(19) United States
(12) Patent Application Publication
(10) Pub. No.: US 2024/0347965 A1
(43) Pub. Date: Oct. 17, 2024

(54) MAGNETIC CONNECTOR WITH ASYMMETRIC ATTACH/DETACH MECHANISM

(71) Applicant: Intel Corporation, Santa Clara, CA (US)

(72) Inventors: Samarth Alva, Bangalore (IN); Jagadish Singh, Bangalore (IN); Prakash Kurma Raju, Bangalore (IN); Arvind S, Bangalore (IN); Jun Liu, Shanghai (CN); Vinaya Kumar Chandrasekhara, Portland, OR (US); Kasthuri Rangan Vijayasarathy, Bangalore (IN); Anoop Parchuru, Bangalore (IN); Smitha Kashyap Chandrachooda, Bangalore (IN)

(21) Appl. No.: 18/740,164

(22) Filed: Jun. 11, 2024

Related U.S. Application Data
(63) Continuation of application No. PCT/CN2023/141818, filed on Dec. 26, 2023.

(30) Foreign Application Priority Data
Dec. 26, 2023 (WO) PCT/CN2023/141818

(51) Int. Cl. H01R 13/62; H01R 13/64

(52) U.S. Cl. CPC H01R 13/6205; H01R 13/64

(57) ABSTRACT

Systems, apparatus, articles of manufacture, and methods are disclosed for magnetic connectors with asymmetric attach/detach mechanism. An example electronic device disclose herein includes a port having an opening to receive a connector and a magnet array associated with the port. The magnet array includes a first magnet, and a second magnet. The electronic device includes a spring to bias at least one of the first magnet or second magnet away from the opening.

### RELATED APPLICATION

This patent arises from a continuation of International Application No. PCT/CN2023/141818, which was filed on Dec. 26, 2023. International Application No. PCT/CN2023/141818 is hereby incorporated herein by reference in its entirety. Priority to International Application No. PCT/CN2023/141818 is hereby claimed.

### BACKGROUND

Mechanical connectors have been used to connect both data and power cables to electronics. However, when a cable extends from a portable computing device, such as a laptop, a person can inadvertently cause the cable to be unplugged at a mechanical connector or the portable computing device can be pulled off a desk or table supporting the same.

### BRIEF DESCRIPTION OF THE DRAWINGS

FIG. 1A illustrates a portion of an example electronic device with an example connector coupled to an example port of the electronic device in accordance with teachings of this disclosure.

FIG. 1B is an enlarged view of the connector and port of FIG. 1A prior to connection or just after release of connection of the connector with the port of the electronic device.

FIG. 2A is a schematic front view of the connector of FIG. 1A.

FIG. 2B is a schematic front view of the port of the electronic device of FIG. 1A.

FIG. 3A is a diagram illustrating the connector of FIG. 1A approaching the port of FIG. 1A with example magnets of the port in a first position.

FIG. 3B is a diagram illustrating the connector of FIG. 1A coupled to the port of FIG. 1A with the magnets of the port in a second position.

FIG. 3C is a diagram illustrating the connector of FIG. 1A approaching the port of FIG. 1A with an example metallic rod in the connector and example magnets of the port in a first position.

FIG. 3D is a diagram illustrating the connector of FIG. 3C coupled to the port with the magnets of the port in a second position.

FIG. 4 is a block diagram of an example implementation of the electronic device of FIG. 1A with example connection detection circuitry.

FIG. 5 is a flowchart representative of example machine readable instructions and/or example operations that may be executed, instantiated, and/or performed by example programmable circuitry to implement the connection detection circuitry of FIG. 4.

FIG. 6 is a block diagram of an example processing platform including programmable circuitry structured to execute, instantiate, and/or perform the example machine readable instructions and/or perform the example operations of FIG. 5 to implement the connection detection circuitry of FIG. 4.

In general, the same reference numbers will be used throughout the drawing(s) and accompanying written description to refer to the same or like parts. The figures are not necessarily to scale. Instead, the thickness of the layers or regions may be enlarged in the drawings.

### DETAILED DESCRIPTION

Mechanical connectors are used for both data and power connectivity for electronics. Attaching a known connector involves proper alignment of the connector with a receptacle or port on the electronic device. Accordingly, a user may visually identify a port and insert a plug of the connector into the port. Further, detaching a known connector can be difficult due to a relatively snug fit. Also, a hanging cable extending from the known connector can cause a computing device to be pulled off a table or other support surface if the cable is snagged and/or pulled. In addition, some service data indicates that 10%-15% of portable computing devices brought for service have problems corresponding to a USB-C port (e.g., not working, internal pins broken, etc.), which may be caused by dropping the devices when pulling on a cable attached thereto.

Some known connectors for connecting power or data sources to electronic device utilize an accessory add-on to couple a plug-side and a receptacle-side. Some other known connectors are difficult to remove from different angles and do not include a visual indication.

Example magnetic connectors with asymmetric attach/detach capabilities and mechanisms are disclosed herein. In asymmetric attach/detach mechanism disclosed herein, the force used to attach the connector to an electronic device is different than, or asymmetric to, the force used to detach the connector from the electronic device. Examples disclosed herein utilize asymmetric forces in insertion/attachment relative to removal/detachment of mating connectors and/or connector portions. Some such examples include magnets with a counteracting spring mechanism to provide the asymmetric forces and provide an improved user experience because a user does not need to visually find and/or locate a port during attachment step. Examples disclosed herein can also reduce a likelihood of a loose connector cable causing issues. Further, examples disclosed herein enable lower detachment force to remove the connectors from a device than conventional connectors, which increases the likelihood that pulling the cable will cause the connector to release from the electronic device without causing the electronic device to fall (e.g., from a table, desk or the like).

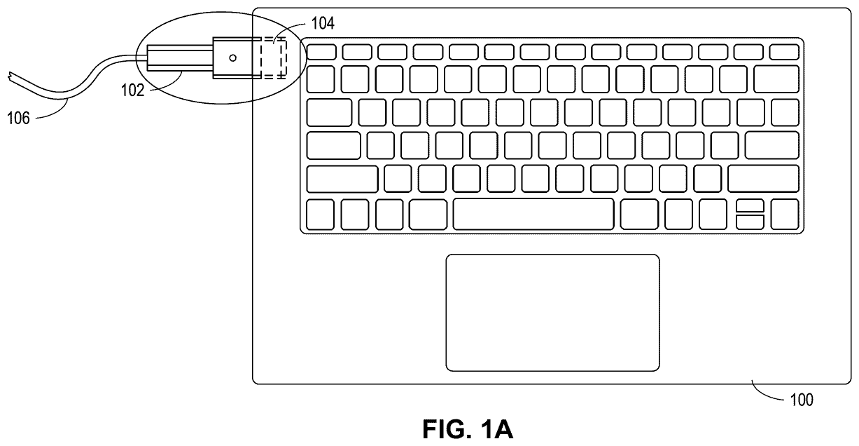

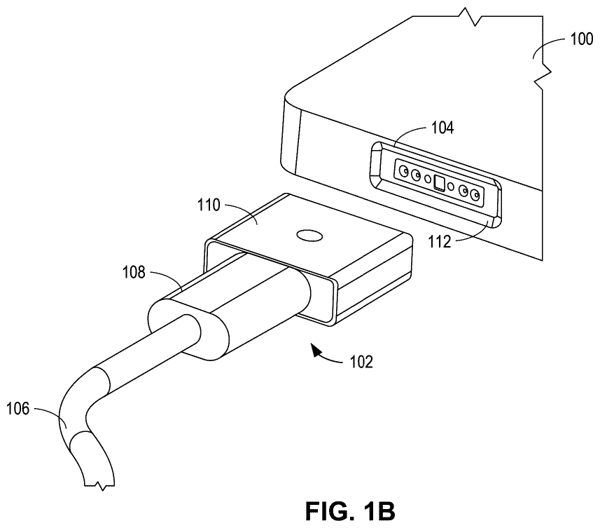

FIG. 1A illustrates a portion of an example electronic device 100 with an example connector 102 coupled to an example port 104 of the electronic device 100. In this example, the electronic device 100 is a laptop or notebook computer. In other examples, the electronic device 100 is any type of device to which a power cord or other accessory is removably coupled. In this example, the connector 102 may provide power and/or data to the electronic device 100. For example, the connector 1023 may be attached to a cable or cord 106 such as a power cable, a display cable, an audio cable, a cable for a downstream device (e.g., Universal Serial Bus type A (USB-A) cable, USB-B, USB-C, or a High-Definition Multimedia Interface (HDMI) cable), etc. Thus, the example cable 106 may run from the connector 102 to, for example, a power source (e.g., AC power), a display, another device, etc.

FIG. 1B is an enlarged view of the connector 102 and the port 104 of FIG. 1A prior to connection to or just after release of the connector 102 from the electronic device 100. In this example, the connector 102 includes an example plug 108 and an example connector accessory 110. In some examples, the connector accessory 110 and the plug 108 are removably couplable. In other examples, the connector accessory 110 and the plug 108 are permanently connected (e.g., integrally formed). The plug 108 and the connector accessory 110 may be permanently connected (e.g., integrally formed) with the cable 106 to form a captive cable. The port 104 of this example includes a beveled or chamfered profile 112 along the edge of the port 104 in the chassis of the electronic device 100, which facilitates alignment and/or receipt of the connector 102.

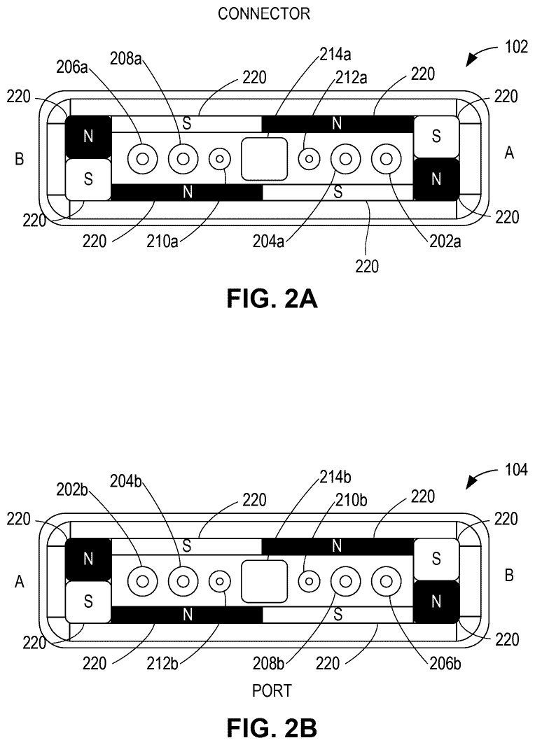

FIG. 2A is a schematic front view of the example connector 102 of FIGS. 1A and 1B. FIG. 2B is a schematic front view of the example port 104 of the electronic device 100 of FIGS. 1A and 1B. The connector 102 and the port 104 includes an example plurality of complementary contacts or pins that align when the connector 102 is coupled to the electronic device 100 in the port 104. When the connector 102 and the port 104 are coupled, side A of the connector 102 in FIG. 2A aligns with side A of the port 104 in FIG. 2B, and side B of the connector 102 in FIG. 2A aligns with side B of the port 102 in FIG. 2B.

The contacts include a first ground pin 202a of the connector 102 that is couplable with a first ground pin 202b of the port 104. The contacts also include a first power supply pin 204a of the connector 102 that is coupled with a first power supply pin 204b of the port 102. The contacts also include a second ground pin 206a of the connector 102 that is couplable with a second ground pin 206b of the port 104. The contacts also include a second power supply pin 208a of the connector 102 that is couplable with a second power supply pin 208b of the port 104. The contacts also include a first signal pin 210a of the connector 102 that is couplable with a first signal pin 210b of the port 102. The contacts also include a second signal pin 212a of the connector 102 that is couplable with a second signal pin 212b of the port 104. In addition, the contacts include another data pin 214a of the connector 102 that is couplable with a data pin 214b of the port 102. In some examples, the data pins 214a, 214b may be Reserved for Future Use (RFU) pins. In the illustrated example, the contacts enable both power and data to be provided over the same connector interface. Thus, the connector 102 can be used for data or file transfer and for power delivery (e.g., an extended power range for Type-C power delivery, where power (e.g., up to 240 Watts) can be delivered. Although the example pins 206a-214b are shown and described, other numbers and/or types of pins may additionally or alternatively be used.

The connector 102 and the port 104 include an example plurality of magnets 220 positioned around the contacts. The magnets 220 of this example may be conventional magnets, polymagnets, electromagnets, and/or a combination of magnet types and/or other ferromagnetic materials. The magnets 220 from respective arrays in corresponding ones of the connector 102 and the port 104. In the illustrated example, the magnets 220 alternate polarities between North and South. The alternating polarities are different polarization orientations. The magnets 220 in the array of the connector 102 are arranged in a complementary manner relative to the arrays of magnets of the port 104 so that when the connector 102 and the port 104 are aligned (side A of the connector 102 aligned with side A of the port 104; and side B of the connector 102 aligned with side B of the port 104), the opposite polarities of the magnets 220 will be aligned and attract one another.

As the connector 102 approaches the port 104, the attractive force of the magnets 220 creates an auto-alignment of the connector 102 and the port 104. Thus, a user does not need to have precise alignment to couple the connector 102 to the port 104. In some examples, visual alignment is not needed. In addition, the chamfered profile 112 of the port 104 guides and/or directs the connector 102 into alignment. In some examples, the magnets 220 and the pins 206a-214b are arranged so that the connector 102 and the port 104 can be coupled in any orientation. For example, the connector 102 can be upside down or downside up and still couple with the port 104. The illustrated example includes eight magnets on each of the connector 102 and the port 104. In other examples, there may be other numbers of magnets 220 included on each of the connector 102 and the port 104 such as two, three, four, etc.

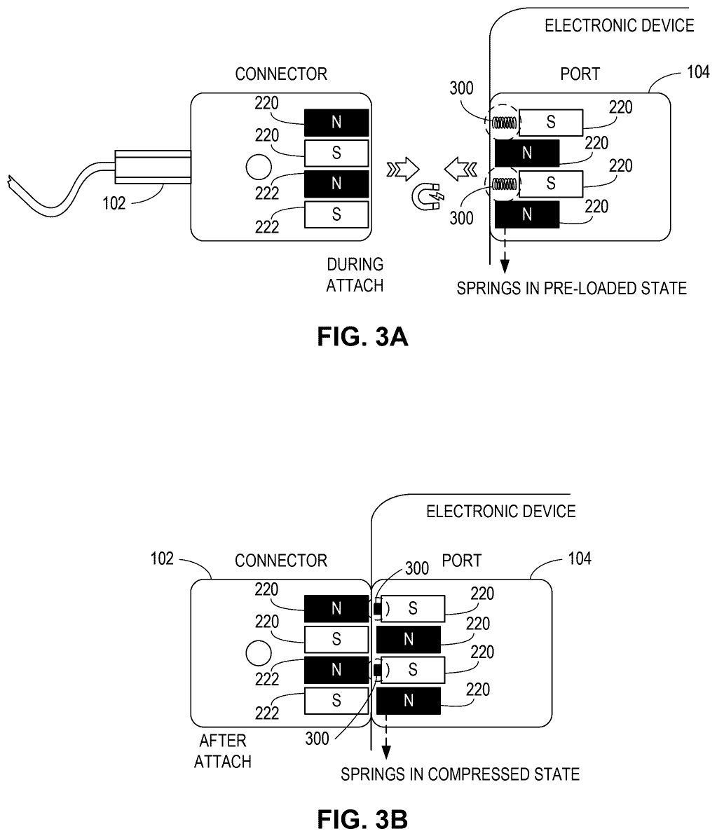

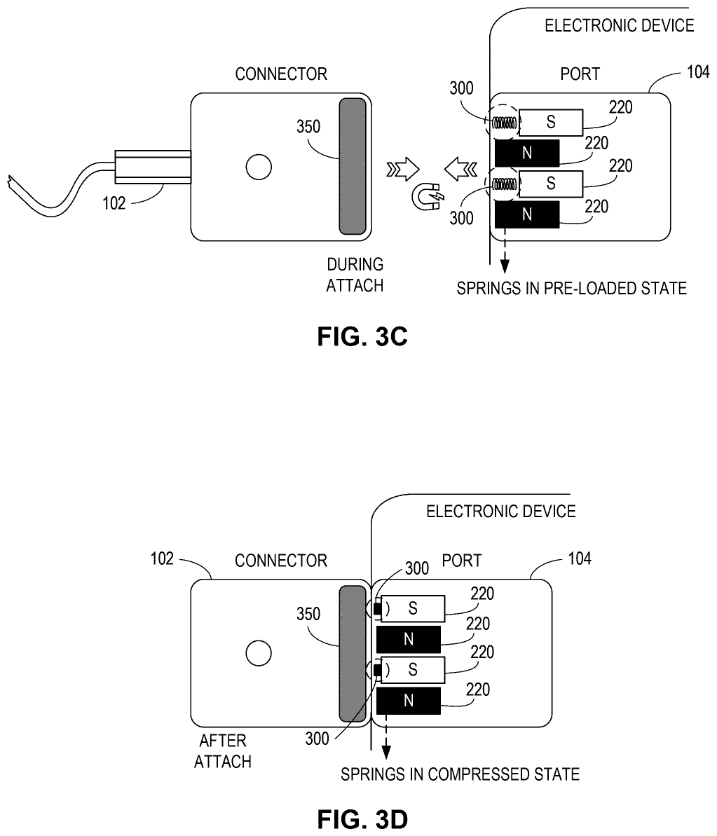

In some examples, one or more of the magnets 220 may be spring-loaded such that the spring-loaded magnets move between a first position and a second position. FIG. 3A is a diagram illustrating such an example connector 102 approaching the port 104 with two magnets 220 of the port 104 in the first position. FIG. 3B is a diagram illustrating the connector 102 of FIG. 3A coupled to the port 104 with the two magnets 220 of the port 104 in the second position. The two magnets 220 of the port 104 are coupled to respective example springs 300. In the first position of FIG. 3A, the springs 300 are in an expanded state. In the second position of FIG. 3B, the springs 300 are in a retracted or compressed state. In the first position, the two spring-loaded magnets 220 are positioned distal to the opening of the port 104. In the second position, the two spring-loaded magnets 220 are positioned proximal the opening of the port 104. The equilibrium state of the springs 300 where the springs 300 are not stretched or compressed is the second position.

As the connector 102 approaches the port 104, the attractive forces of the magnets 220 pull the magnets in the connector 102 toward the magnets 220 in the port 104. In this example, the magnetic force is greater than the spring force of the springs 300. Thus, the magnetic force compresses the springs 300 and draws the spring-loaded magnets 220 from the first position toward the second position.

The force of the springs 300 counteracts the magnetic force attracting the magnets 220 of the connector 102 and the magnets 220 of the port 104. In other words, the springs 300 actively push against the magnetic force. As the magnets 220 separate, the magnetic force decreases. The decreasing magnetic force is coupled with the spring force that acts to separate the magnets 220 further, which in turn further decreases the magnetic force. Thus, less force is used to disconnect the connector 102 from the port 104 than is used to couple the connector 102 to the port 104. The lower force for disconnecting the connector 102 from the port 104 is asymmetric to the higher force for connecting the connector 102 to the port 104. As the connector 102 is pulled away from the port 104, the springs 300 act to push the spring-loaded magnets 220 to the second position. The spring force facilitates disconnection of the connector 102 from the port 104. The springs 300 enable easier removal of the connector 102 from the port 104.

For example, if there is a force of 50 Newtons (N) between a magnetic attraction of a pair of N—S magnets, and four such pairs are included between the connector 102 and the port 104, there would be an attach force and a detach force of 200 N where no springs are present. When two springs are present, an attach force of 180 N and a detachment force of 80 N. In this example, without the springs 300, the attach and detach forces are substantially symmetric. In contrast, with the springs 300, the detach force is significantly different from or asymmetric to the attach force.

Though two springs 300 are shown in the illustrated example, in other examples there may be other numbers of springs such as one, three, four etc. Though the springs 300 are shown loading the S end of the magnets 220, in other examples, the springs 300 may load the N end of the magnets 220 or load a combination of N and S ends of magnets. Though the springs 300 are shown coupled to magnets 220 of the port 104, in other examples the springs 300 may be coupled to magnets 220 in the connector 220 or to a combination of magnets 220 in the connector 102 and the port 104. Though the springs 300 are shown loading a single magnet 220 each, in other examples, a spring 300 may load two or more (e.g., multiple) magnets 220.

FIGS. 3C and 3D illustrate alternative structure that operates similar to the example of FIGS. 3A and 3B. In the example of FIGS. 3C and 3D, the connector 102 does not include the magnets 220 but does include an example rod 350. The rod 350 includes a metallic and/or ferromagnetic material. In some examples, the rod 350 includes steel alloy. In some examples, the rod 350 is a plate, a cylinder, a rectangular prism, one or more cubes, or other suitable shape. FIG. 3C illustrates the connector 102 approaching the port 104 with two magnets 220 of the port 104 in the first position. FIG. 3D illustrates the connector 102 of FIG. 3A coupled to the port 104 with the two magnets 220 of the port 104 in the second position. In the first position of FIG. 3C, the springs 300 are in the expanded state. In the second position of FIG. 3D, the springs 300 are in the retracted or compressed state. In the first position, the two spring-loaded magnets 220 are positioned distal to the opening of the port 104. In the second position, the two spring-loaded magnets 220 are positioned proximal the opening of the port 104. The equilibrium state of the springs 300 where the springs 300 are not stretched or compressed is the second position.

As the connector 102 approaches the port 104, the attractive forces of the magnets 220 pull the magnets 220 of the port and the rod 350 in the connector 102 toward each other. In this example, the magnetic force is greater than the spring force of the springs 300. Thus, the magnetic force compresses the springs 300 and draws the spring-loaded magnets 220 from the first position toward the second position.

The force of the springs 300 counteracts the magnetic force attracting the magnets 220 of the port 104 with the rod 350 of the connector 102. In other words, the springs 300 actively push against the magnetic force. As the magnets 220 and the rod 350 separate, the magnetic force decreases. The decreasing magnetic force is coupled with the spring force that acts to separate the magnets 220 from the rod 350 further, which in turn further decreases the magnetic force. Thus, less force is used to disconnect the connector 102 from the port 104 than is used to couple the connector 102 to the port 104. The lower force for disconnecting the connector 102 from the port 104 is asymmetric to the higher force for connecting the connector 102 to the port 104. As the connector 102 is pulled away from the port 104, the springs 300 act to push the spring-loaded magnets 220 to the second position. The spring force facilitates disconnection of the connector 102 from the port 104. The springs 300 enable easier removal of the connector 102 from the port 104.

Though two springs 300 are shown in the illustrated example, in other examples there may be other numbers of springs such as one, three, four etc. Though the springs 300 are shown loading the S end of the magnets 220, in other examples, the springs 300 may load the N end of the magnets 220 or load a combination of N and S ends of magnets. Though the springs 300 are shown loading a single magnet 220 each, in other examples, a spring 300 may load two or more (e.g., multiple) magnets 220. Though the springs 300 and the magnets 220 are shown in the port 104 and the rod 350 is in the connector 103, in other examples the springs and the magnets 220 may be in the connector 220 and the rod 350 may be in the port 104. In other examples, there may be a combination of magnets 220 and rods 350 mixed between the connector 102 and the port 104.

The examples of FIGS. 3A-D illustrate coil springs. In other examples, the springs 300 may include conical springs, spring contacts, leaf springs, other cantilevered mechanism, other biasing devices, etc. The springs 300 represent devices that impart a force when released from a compressed state to a relaxed state.

In some examples, the number springs 300, the placement of the springs 300, the spring index or stiffness, etc. and/or the number of magnet 220, the placement of magnets 220, the strength of magnets 220, etc. may be variable and selected based on a target audience and/or a target product type. For example, electronic devices for children or elderly people may include relatively stiffer springs and/or weaker magnets that enable easier detachment of the connector 102 from the port 104. Electronic devices for gaming purposes may include relatively more elastic springs and/or stronger magnets that require relatively more force to decouple the connector 102 from the port 104.

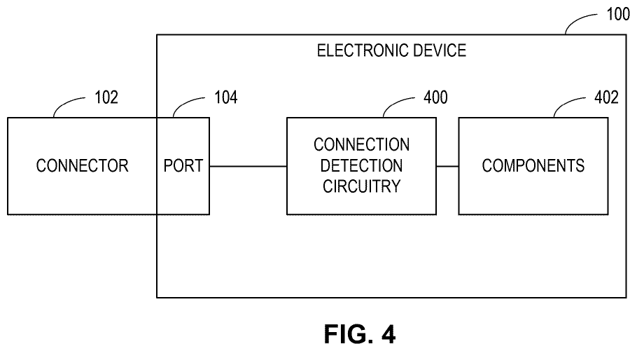

FIG. 4 is a block diagram of an example implementation of the electronic device 100 with example connection detection circuitry 400 and example components 402. The connection detection circuitry 400 detects when the connector 102 is coupled to the port 104. For example, the connection detection circuitry 400 detects the compression of the springs 300, the coupling of the magnets 220, and/or the connection of the complementary contacts 206a-214b. When the connection detection circuitry 400 detects that the connector 102 is coupled to the port 104, the connection detection circuitry 400 can cause one or more other components 402 of the electronic device 100 to take action. For example, based on the connection of the connector 102 to the port 104, the components 402 can launch a program, change an operating mode of the electronic device 100, exchange data with a device coupled to the connector 102, charge a battery, and/or otherwise take other actions associated with recognizing the connectivity of a device through the connector 102.

FIG. 4 is a block diagram of an example implementation of the electronic device 100 of FIG. 1 to detect connection of the connector 102 with the port 104. The connection detection circuitry 400 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the connection detection circuitry 400 of FIG. 4 may be instantiated (e.g., creating an instance of, bring into being for any length of time, materialize, implement, etc.) by (i) an Application

Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

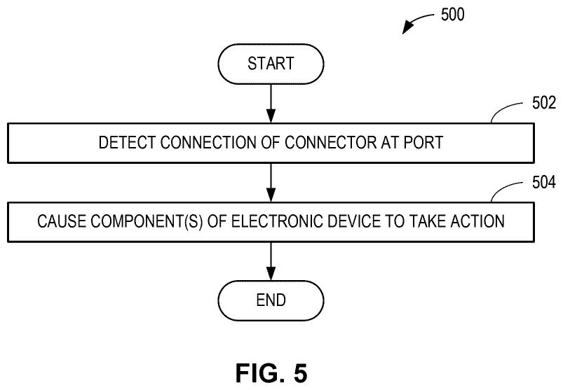

In some examples, the connection detection circuitry 400 is instantiated by programmable circuitry executing connection detection instructions and/or configured to perform operations such as those represented by the flowchart(s) of FIG. 5.

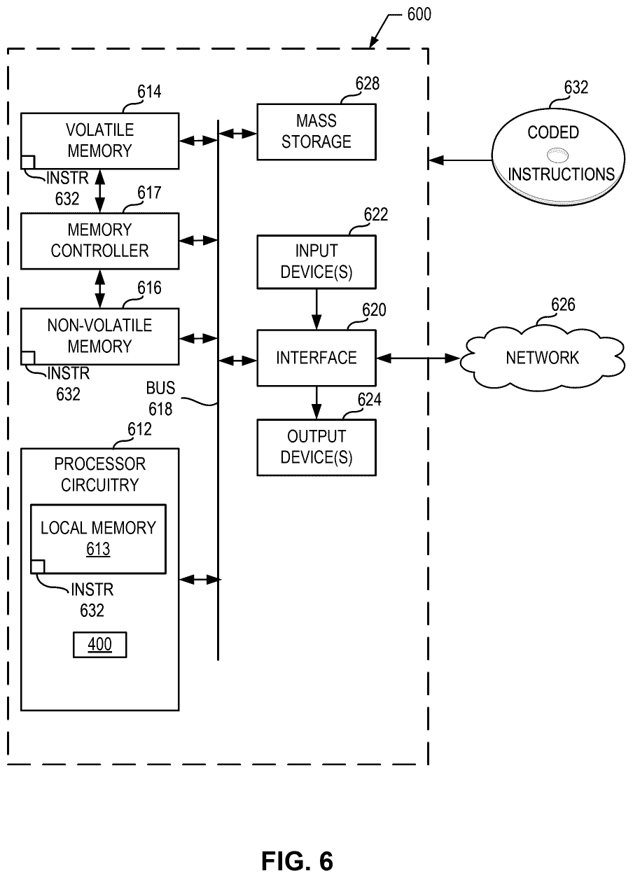

In some examples, the electronic device 100 includes means for detecting a connection of a device. For example, the means for detecting may be implemented by connection detection circuitry 400. In some examples, the connection detection circuitry 400 may be instantiated by programmable circuitry such as the example programmable circuitry 612 of FIG. 6. In some examples, the connection detection circuitry 400 may be instantiated by hardware logic circuitry, which may be implemented by an ASIC, XPU, or the FPGA circuitry configured and/or structured to perform operations corresponding to the machine readable instructions. Additionally or alternatively, the connection detection circuitry 400 may be instantiated by any other combination of hardware, software, and/or firmware. For example, the connection detection circuitry 400 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the connection detection circuitry 400 is illustrated in FIG. 4, one or more of the elements, processes, and/or devices illustrated in FIG. 4 may be combined, divided, re-arranged, omitted, eliminated, and/or implemented in any other way. Further, the connection detection circuitry 400 FIG. 4, may be implemented by hardware alone or by hardware in combination with software and/or firmware. Thus, for example, the connection detection circuitry 400, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example connection detection circuitry 400 of FIG. 4 and/or the electronic device 100 may include one or more elements, processes, and/or devices in addition to, or instead of, those illustrated in FIG. 4, and/or may include more than one of any or all of the illustrated elements, processes and devices.

Flowchart(s) representative of example machine readable instructions, which may be executed by programmable circuitry to implement and/or instantiate the connection detection circuitry 400 of FIG. 4 and/or the electronic device 100 and/or representative of example operations which may be performed by programmable circuitry to implement and/or instantiate the connection detection circuitry 400 of FIG. 4 and/or the electronic device 100, are shown in FIG. 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 5, many other methods of implementing the example connection detection circuitry 400 and/or the electronic device 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to detect connection of the connector 102 at the port 104. The example machine-readable instructions and/or the example operations 500 of FIG. 5 include the connection detection circuitry 400 detecting when the connector 102 is coupled to the port 104 (block 502). For example, the connection detection circuitry 400 detects the compression of the springs 300, the coupling of the magnets 220, and/or the connection of the complementary contacts 206a-214b. When the connection detection circuitry 400 detects that the connector 102 is coupled to the port 104, the connection detection circuitry 400 causes one or more other components 402 of the electronic device 100 to take action (block 504). For example, based on the connection of the connector 102 to the port 104, the components 402 can launch a program, change an operating mode of the electronic device 100, exchange data with a device coupled to the connector 102, charge a battery, and/or otherwise take other actions associated with recognizing the connectivity of a device through the connector 102.

FIG. 6 is a block diagram of an example programmable circuitry platform 600 structured to execute and/or instantiate the example machine-readable instructions and/or the example operations of FIG. 5 to implement the connection detection circuitry 400 of FIG. 4. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAS, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the connection detection circuitry 400.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIG. 5, may be stored in the mass storage device 628, in the volatile memory 614, in the non-volatile memory 616, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable an improved user interface by utilizing an arrangement of magnets such that at least some of the magnets are biased (e.g., spring-loaded and/or mechanically urged by one or more other devices). As a result, an insertion of a connector (e.g., a power cord or accessory device) has an attractive force that is greater than a detachment force, which can be a more intuitive experience for a user. The lower detachment force facilitates removal of the connector 102 from the port 104 which can reduce hazards if a person inadvertently snags (e.g., walks into the cord 106 and/or reduces likelihood of damaging to the electronic device 100, the contacts 206a-214b in the connector 102, and/or the port 104.

Examples disclosed herein can provide a positive user experience in terms of a connection interface without necessitating a visually identification of a port. Examples disclosed herein can facilitate disconnection by asymmetric attach/detach forces from wide range of angles including, axial pull and/or off-axis pull by utilizing an effective arrangement of movable/displaced magnets.

Systems, apparatus, articles of manufacture, and methods are disclosed for magnetic connectors with asymmetric attach/detach mechanism. Example 1 includes an electronic device disclose herein includes a port having an opening to receive a connector and a magnet array associated with the port. The magnet array includes a first magnet, and a second magnet. The electronic device includes a spring to bias at least one of the first magnet or second magnet away from the opening.

Example 2 includes the electronic device of Example 1, wherein the first magnet has a first polarization orientation, and the second magnet has a second polarization orientation different from the first polarization orientation.

Example 3 includes the electronic device of any of Examples 1-2, wherein the port include a plurality of contacts adjacent to the magnet array.

Example 4 includes the electronic device of Example 3, wherein the plurality of contacts support at least one of data transfer or power supply.

Example 5 includes the electronic device of any of Examples 1-4,

wherein a magnetic force associated with at least one of the first magnet or the second magnet compress the spring when the connector is coupled to the port.

Example 6 includes a system that includes an electronic device including: a port having an opening; a magnet array in the port, the magnet array including: a first magnet, and a second magnet; and a spring to bias the second magnet away from the opening; and a connector removably couplable with the port.

Example 7 includes the system of Example 6, wherein the magnet array is a first magnet array, the connector including a second magnet array, the second magnet array including a third magnet and a fourth magnet, the third magnet attracted to the first magnet when the connector is coupled to the port, and the fourth magnet attracted to the second magnet when the connector is coupled to the port.

Example 8 includes the system of Example 7, wherein the second magnet and the fourth magnet cause the spring to compress when the connector is coupled to the port.

Example 9 includes the system of any of Examples 7-8, wherein the spring biases the second magnet away from the fourth magnet.

Example 10 includes the system of any of Examples 7-9, wherein a force of the spring is less than an attractive force between the second magnet and the fourth magnet when the connector and the port are coupled.

Example 11 includes the system of any of Examples 7-10, wherein the first magnet and the second magnet have opposite polarization orientations, and the third magnet and the fourth magnet have opposite polarization orientations.

Example 12 includes the system of any of Examples 6-11, wherein an attach force to couple the connector to the port is greater than a detach force to decouple the connector from the port.

Example 13 includes the system of any of Examples 12, wherein the detach force is based on a stiffness of the spring.

Example 14 includes the system of any of Examples 6-13, wherein the first magnet has a first polarization orientation, and the second magnet has a second polarization orientation different than the first polarization orientation.

Example 15 includes the system of any of Examples 6-14, wherein the second magnet is movable.

Example 16 includes the system of any of Examples 6-15, wherein the second magnet is in a first position relative to the port when the connector is coupled to the port, and the second magnet is in a second position relative to the port when the connector is detached from the port.

Example 17 includes the system of Example 16, wherein the spring moves the second magnet toward the second position when the connector and the port are separated.

Example 18 includes the system of any of Examples 6-17, wherein the connector includes a third magnet that is attracted to the second magnet, and attraction of the second magnet and third magnet compresses the spring.

Example 19 includes the system of any of Examples 6-18, wherein the connector includes a ferromagnetic rod that is attracted to at least one of the first magnet or the second magnet.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An electronic device comprising:
a port having an opening to receive a connector;
a magnet array associated with the port, the magnet array including:
a first magnet, and
a second magnet; and
a spring to bias the first magnet or the second magnet away from the opening.

2. The electronic device of claim 1, wherein the first magnet has a first polarization orientation, and the second magnet has a second polarization orientation different from the first polarization orientation.

3. The electronic device of claim 1, wherein the port include a plurality of contacts adjacent to the magnet array.

4. The electronic device of claim 3, wherein the plurality of contacts support data transfer or power supply.

5. The electronic device of claim 1, wherein a magnetic force associated with the first magnet or the second magnet compress the spring when the connector is coupled to the port.

6. A system comprising:
an electronic device including:
a port having an opening;
a magnet array in the port, the magnet array including:
a first magnet, and
a second magnet; and
a spring to bias the second magnet away from the opening; and
a connector removably couplable with the port.

7. The system of claim 6, wherein the magnet array is a first magnet array, wherein the connector comprises a second magnet array, wherein the second magnet array comprises a third magnet and a fourth magnet, wherein the third magnet is attracted to the first magnet when the connector is coupled to the port, and wherein the fourth magnet is attracted to the second magnet when the connector is coupled to the port.

8. The system of claim 7, wherein the second magnet and the fourth magnet cause the spring to compress when the connector is coupled to the port.

9. The system of claim 7, wherein the spring biases the second magnet away from the fourth magnet.

10. The system of claim 7, wherein a force of the spring is less than an attractive force between the second magnet and the fourth magnet when the connector and the port are coupled.

11. The system of claim 7, wherein the first magnet and the second magnet comprise opposite polarization orientations, and the third magnet and the fourth magnet comprise opposite polarization orientations.

12. The system of claim 6, wherein an attach force to couple the connector to the port is greater than a detach force to decouple the connector from the port.

13. The system of claim 12, wherein the detach force is based on a stiffness of the spring.

14. The system of claim 6, wherein the first magnet comprises a first polarization orientation, and the second magnet comprises a second polarization orientation different than the first polarization orientation.

15. The system of claim 6, wherein the second magnet is movable.

16. The system of claim 6, wherein the second magnet is in a first position relative to the port when the connector is coupled to the port, and the second magnet is in a second position relative to the port when the connector is detached from the port.

17. The system of claim 16, wherein the spring moves the second magnet toward the second position when the connector and the port are separated.

18. The system of claim 6, wherein the connector includes a third magnet that is attracted to the second magnet, and attraction of the second magnet and third magnet compresses the spring.

19. The system of claim 6, wherein the connector includes a ferromagnetic rod that is attracted to the first magnet or the second magnet.
